(19) United States
(12) Patent Application Publication
(10) Pub. No.: US 2025/0287165 A1
(43) Pub. Date: Sep. 11, 2025

(54) WIRE DAMPER OF LOUDSPEAKER HAVING MULTIFILAMENT WIRES AND METHOD FOR MANUFACTURING THE SAME

(71) Applicant: Hiroko OHARA, Taoyuan (TW)

(72) Inventor: Hiroko OHARA, Taoyuan (TW)

(21) Appl. No.: 18/645,492

(22) Filed: Apr. 25, 2024

(30) Foreign Application Priority Data
Mar. 5, 2024 (TW) 113108007

(51) Int. Cl. H04R 31/00; D02G 3/04; D02G 3/12; D02G 3/44; D03D 1/00; D03D 15/47; D03D 15/67; H04R 9/04

(52) U.S. Cl. CPC H04R 31/00; D02G 3/04; D02G 3/12; D02G 3/44; D03D 1/00; D03D 15/47; D03D 15/67; H04R 9/043

(57) ABSTRACT

A method for manufacturing a wire damper of a loudspeaker having multifilament wires, including: blend-twisting two metal yarns into one di-filament wire; blend-twisting or braiding a plurality of di-filament wires into one multifilament wire; weaving yarns into a base material, and disposing a plurality of multifilament wires on the base material; impregnating the base material in a resin solution; drying the base material to form a solid resin layer on the base material; forming a wire damper of a loudspeaker on the base material by thermoforming; and separating the wire damper of the loudspeaker from the base material. Thereby, the multifilament wires are formed by blend-twisting or braiding a plurality of the di-filament wires, which has better structural strength and is not prone to be damaged due to the heat and pressing of the forming mold, and breakage of the multifilament wires will not occur even after long-term use.

### CROSS-REFERENCE TO RELATED APPLICATION

This application claims the priority of Taiwanese patent application No. 113108007, filed on Mar. 5, 2024, which is incorporated herewith by reference.

### BACKGROUND OF THE INVENTION

### 1. Field of the Invention

The present invention relates to a wire damper of a loudspeaker and a method for manufacturing the same, and more particularly, to a wire damper of a loudspeaker having multifilament wires and a method for manufacturing the same.

### 2. The Prior Arts

In the general moving coil loudspeaker, the principle that the reaction force of a fixed magnetic field causes another magnetic field to move in the opposite direction (i.e., opposite magnetisms attract each other, and like magnetisms repel each other) is used to produce sound. Further, the power alternating current generated by the power amplifier is transmitted to the voice coil through a wire to change the polarity of the magnetic field, such that the voice coil generates a reaction force against the fixed magnetic region generated by the magnetic circuit device. A positive pulse causes an outward motion of the diaphragm relative to the magnet, while a negative pulse causes an inward motion of the diaphragm. When the voice coil pushes the diaphragm to reciprocate, the diaphragm pushes air, and the air pressure changes to form sound waves. The damper is responsible for maintaining the voice coil at a correct position in the gap of the magnet core, ensuring that the voice coil reciprocates along the axis direction when being forced.

The conventional method for manufacturing a wire damper of a loudspeaker comprises: using cotton fabric as a base material, disposing a plurality of wires on the base material, and subjecting the base material to the steps such as impregnating in resin, drying, thermoforming, and cutting, in order to obtain a wire damper of a loudspeaker.

However, each wire is generally formed by twisting a single metal yarns or braiding multiple metal yarns, which has poor structural strength. During the thermoforming step, the wires are prone to be damaged due to the heat and pressing of the forming mold. After long-term use, the problem of damaging the wires will become increasingly serious, and a problem of breakage of the wire may even occur.

### SUMMARY OF THE INVENTION

A main objective of the present invention is to provide a wire damper of a loudspeaker having multifilament wires and a method for manufacturing the same, which can provide multifilament wires with a better structural strength.

In order to achieve the above objective, the present invention provides a method for manufacturing a wire damper of a loudspeaker having multifilament wires, comprising the following steps: blend-twisting two metal yarns into one di-filament wire; blend-twisting or braiding a plurality of the di-filament wires into one multifilament wire; weaving a plurality of yarns into a base material, and disposing a plurality of the multifilament wires on the base material; impregnating the base material in a resin solution; drying the base material to form a solid resin layer on the base material; forming a wire damper of a loudspeaker on the base material by thermoforming; and separating the wire damper of the loudspeaker from the base material.

In some embodiments, the metal yarns are made of different materials or a same material.

In some embodiments, in the step of weaving the base material, a plurality of warp yarns of the yarns and the multifilament wires extend straightly and are parallel to each other, and a plurality of weft yarns of the yarns extend straightly and are perpendicular to the warp yarns and the multifilament wires.

In some embodiments, in the step of weaving the base material, a plurality of warp yarns of the yarns extend straightly and are parallel to each other, and a plurality of weft yarns of the yarns and the multifilament wires extend straightly and are perpendicular to the warp yarns.

In some embodiments, in the step of weaving the base material, the multifilament wires are woven, sewn, adhered, or sandwiched into the base material.

In order to achieve the above objective, the present invention provides a wire damper of a loudspeaker having multifilament wires, which comprises a main body, a plurality of multifilament wires and a solid resin layer. The main body is woven from a plurality of yarns. The multifilament wires are disposed on the main body, wherein each multifilament wire is formed by blend-twisting or braiding a plurality of di-filament wires, and each di-filament wire is formed by blend-twisting two metal yarns. The solid resin layer covers surfaces of the yarns and the multifilament wires.

In some embodiments, the metal yarns are made of different materials or a same material.

In some embodiments, the yarns comprise a plurality of warp yarns and a plurality of weft yarns, the warp yarns and the multifilament wires extend straightly and are parallel to each other, and the weft yarns extend straightly and are perpendicular to the warp yarns and the multifilament wires.

In some embodiments, the yarns comprise a plurality of warp yarns and a plurality of weft yarns, the warp yarns extend straightly and are parallel to each other, and the weft yarns and the multifilament wires extend straightly and are perpendicular to the warp yarns.

In some embodiments, the multifilament wires are woven, sewn, adhered, or sandwiched into the main body.

The effect of the present invention is that the multifilament wires are formed by blend-twisting or braiding a plurality of the di-filament wires, which has a better structural strength and is not prone to be damaged due to the thermoforming of the mold, and the problem of breakage of the multifilament wires will not occur even after long-term use.

### BRIEF DESCRIPTION OF THE DRAWINGS

FIG. 1 is a flow diagram of a manufacturing method of the present invention;

FIG. 2 is a schematic diagram of steps S10 to S30 of a manufacturing method of a first embodiment of the present invention;

FIG. 3 is a schematic diagram of steps S40 to S70 of the manufacturing method of the first embodiment of the present invention;

FIG. 4 is a perspective view of a wire damper of a loudspeaker of the first embodiment of the present invention;

FIG. 5 is a schematic diagram of a region A of FIG. 4;

FIG. 6 is a schematic diagram of steps S10 to S30 of a manufacturing method of a second embodiment of the present invention;

FIG. 7 is a perspective view of a wire damper of a loudspeaker of the second embodiment of the present invention;

FIG. 8 is a schematic diagram of a region B of FIG. 7;

FIG. 9 is a schematic diagram of steps S10 to S30 of a manufacturing method of a third embodiment of the present invention;

FIG. 10 is a perspective view of a wire damper of a loudspeaker of the third embodiment of the present invention;

FIG. 11 is a schematic diagram of a region C of FIG. 10;

FIG. 12 is a schematic diagram of steps S10 to S30 of a manufacturing method of a fourth embodiment of the present invention;

FIG. 13 is a perspective view of a wire damper of a loudspeaker of the fourth embodiment of the present invention; and

FIG. 14 is a schematic diagram of a region D of FIG. 13.

### DETAILED DESCRIPTION OF THE PREFERRED EMBODIMENT

Hereinafter, embodiments of the present invention will be described in more detail with reference to the drawings and the reference numerals, such that those skilled in the art can implement it after studying this specification.

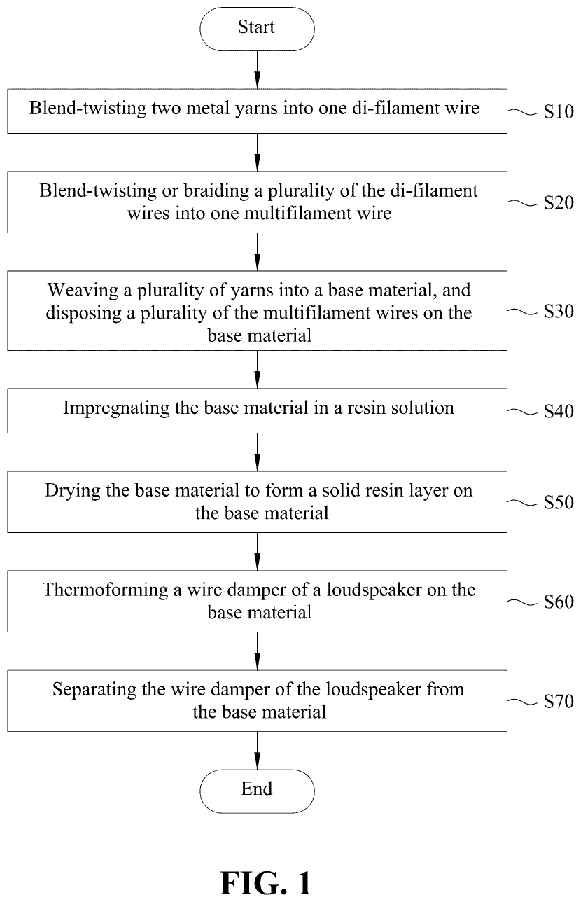

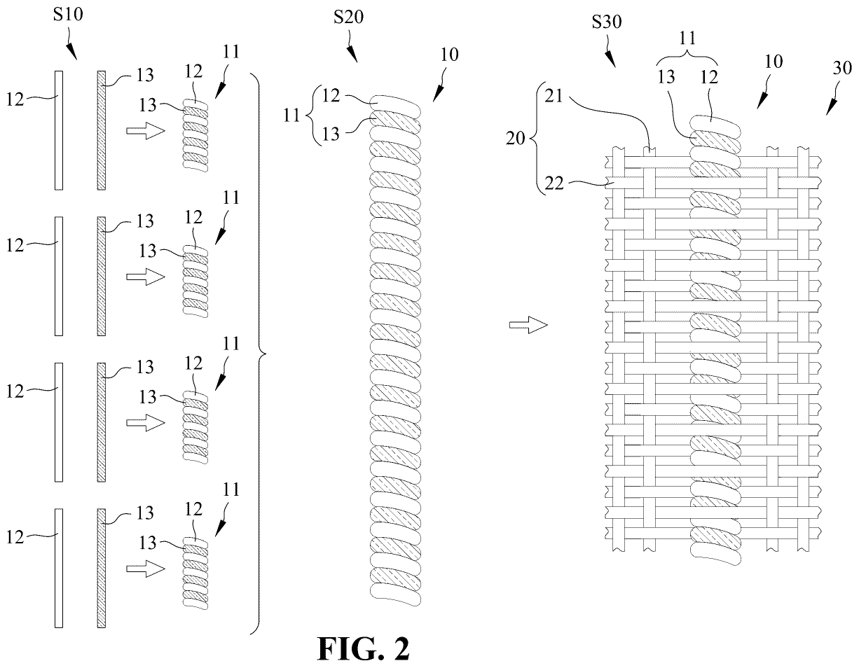

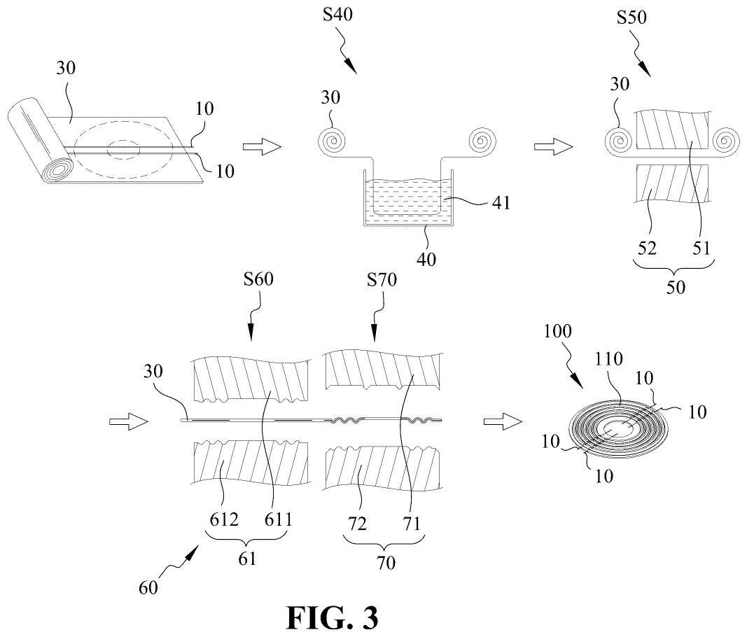

FIG. 1 is a flow diagram of a manufacturing method of the present invention. FIG. 2 is a schematic diagram of steps S10 to S30 of a manufacturing method of a first embodiment of the present invention. FIG. 3 is a schematic diagram of steps S40 to S70 of the manufacturing method of the first embodiment of the present invention. The present invention provides a method for manufacturing a wire damper of a loudspeaker having multifilament wires, comprising the following steps S10 to S70:

In the step S10, as shown in FIGS. 1 and 2, two metal yarns 12 and 13 are blend-twisted into one di-filament wire 11, and the metal yarns 12 and 13 are made of different materials or a same material.

In the step S20, as shown in FIGS. 1 and 2, a plurality of the di-filament wires 11 are blend-twisted into one multifilament wire 10.

In the step S30, as shown in FIGS. 1 and 2, a plurality of yarns 20 are woven into a base material 30, and a plurality of the multifilament wires 10 are disposed on the base material. Specifically, a plurality of warp yarns 21 of the yarns 20 and the multifilament wires 10 extend straightly and are parallel to each other, and a plurality of weft yarns 22 of the yarns 20 extend straightly and are perpendicular to the warp yarns 21 and the multifilament wires 10.

In the first embodiment, in the step S30, the warp yarns 21 and the multifilament wires 10 are arranged at intervals, the warp yarns 21 and the multifilament wires 10 extend straightly and are parallel to each other, and the weft yarns 22 are interwoven with the warp yarns 21 and the multifilament wires 10 to weave the base material 30.

In some embodiments, in the step S30, the multifilament wires 10 are sewn on the base material 30 by a plurality of sewing threads. In some embodiments, in the step S30, the multifilament wires 10 are adhered on the base material 30 by a plurality of adhesive layers. In some embodiments, in the step S30, the multifilament wires 10 are sandwiched between two base materials 30.

In the step S40, as shown in FIGS. 1 and 3, the base material 30 is impregnated in a resin solution 41 in a resin tank 40, such that the warp yarns 21, the weft yarns 22 and the multifilament wires 10 adsorb the resin and are adhered with the resin.

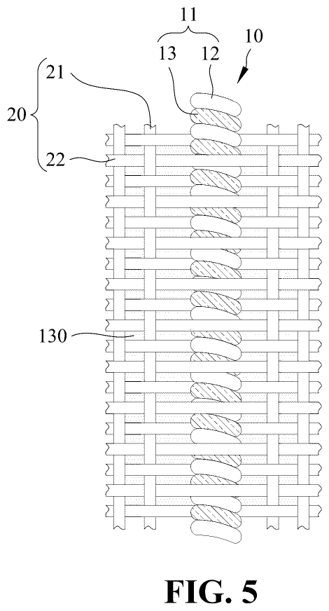

In the step S50, as shown in FIGS. 1 and 3, a drying device 50, which includes an upper baking plate 51 and a lower baking plate 52, is used, wherein by utilizing the temperature of the upper baking plate 51 and the lower baking plate 52, the moisture and volatile substances in the resin on the base material 30 are removed such that the base material 30 is dried; meanwhile, the resin penetrates into the base material 30 and is adhered onto the warp yarns 21, the weft yarns 22 and the multifilament wires 10, so as to form a solid resin layer 130 (referring to FIG. 5), the solid resin layer 130 covers surfaces of the warp yarns 21, the weft yarns 22 and the multifilament wires 10.

In the step S60, as shown in FIGS. 1 and 3, a thermoforming device 60, which includes a forming mold 61 and a heating device (not shown), is used, wherein the forming mold 61 includes an upper mold 611 and a lower mold 612. When the upper mold 611 and the lower mold 612 fit together and press the base material 30, the heating device is applied with electricity to increase the temperature of the upper mold 611 and the lower mold 612 to 190° C. to 270° C., thereby softening the resin on the base material 30. In addition that the resin structure is broken, the resin also fills up the gaps, and thus respective parts of the resin are connected with each other to form the final morphology of the solid resin layer 130, so as to cover between the warp yarns 21, the weft yarns 22 and the multifilament wires 10, thereby forming a wire damper of loudspeaker 100 on the base material 30 by thermoforming.

In the step S70, as shown in FIGS. 1 and 3, a cutting device 70, which includes an upper cutting tool 71 and a lower cutting tool 72, is used, wherein the wire damper of loudspeaker 100 is cut from the base material 30 by the upper cutting tool 71 and the lower cutting tool 72, such that the wire damper of loudspeaker 100 is separated from the base material 30.

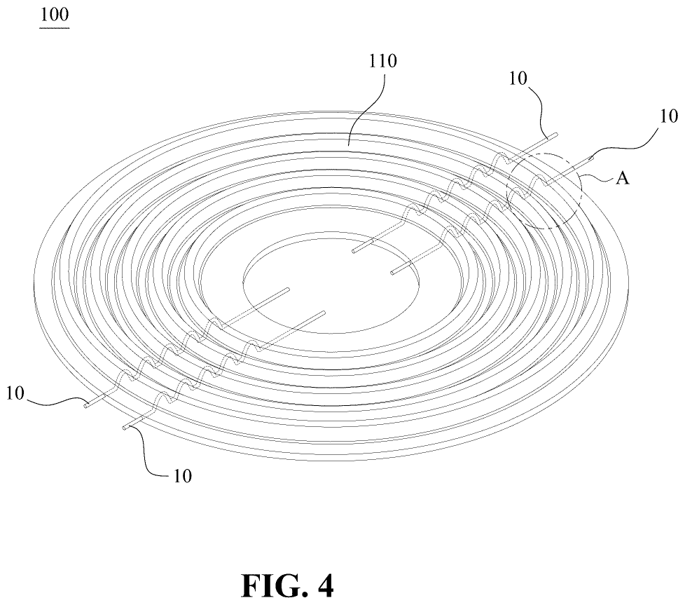

FIG. 4 is a perspective view of a wire damper of loudspeaker 100 of the first embodiment of the present invention. FIG. 5 is a schematic diagram of a region A of FIG. 4. As shown in FIGS. 4 and 5, the present invention provides a wire damper of loudspeaker 100 having multifilament wires, which comprises a main body 110, a plurality of multifilament wires 10 and a solid resin layer 130. The main body 110 is woven from a plurality of yarns 20. Each multifilament wire 10 is formed by blend-twisting a plurality of di-filament wires 11, and each di-filament wire 11 is formed by blend-twisting two metal yarns 12 and 13, and the metal yarns 12 and 13 are made of different materials or a same material. The solid resin layer 130 covers surfaces of the yarns 20 and the multifilament wires 10.

Specifically, the yarns 20 comprise a plurality of warp yarns 21 and a plurality of weft yarns 22, the warp yarns 21 and the multifilament wires 10 extend straightly and are parallel to each other, and the weft yarns 22 extend straightly and are perpendicular to the warp yarns 21 and the multifilament wires 10.

In the first embodiment, the warp yarns 21 and the multifilament wires 10 are arranged at intervals, the warp yarns 21 and the multifilament wires 10 extend straightly and are parallel to each other, and the weft yarns 22 are interwoven with the warp yarns 21 and the multifilament wires 10 to weave the main body 110.

In some embodiments, the multifilament wires 10 are sewn on the main body 110 by a plurality of sewing threads. In some embodiments, the multifilament wires 10 are adhered on the main body 110 by a plurality of adhesive layers. In some embodiments, the multifilament wires 10 are sandwiched between two main bodies 110.

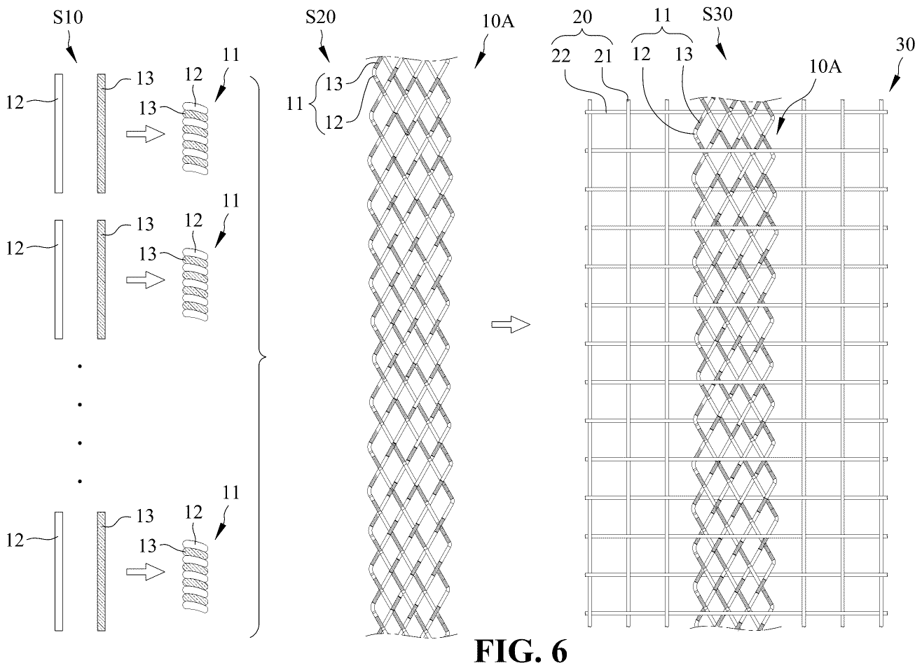

FIG. 6 is a schematic diagram of steps S10 to S30 of a manufacturing method of a second embodiment of the present invention. As shown in FIG. 6, in terms of method, the second embodiment is different from the first embodiment in that in the step S20, a plurality of the di-filament wires 11 are braided into one multifilament wire 10A. Otherwise, the other technical features of the second embodiment are exactly the same as those of the first embodiment.

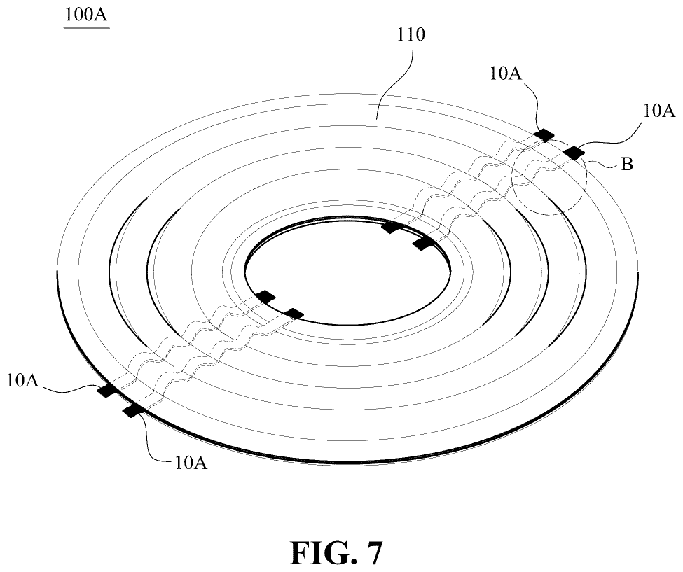

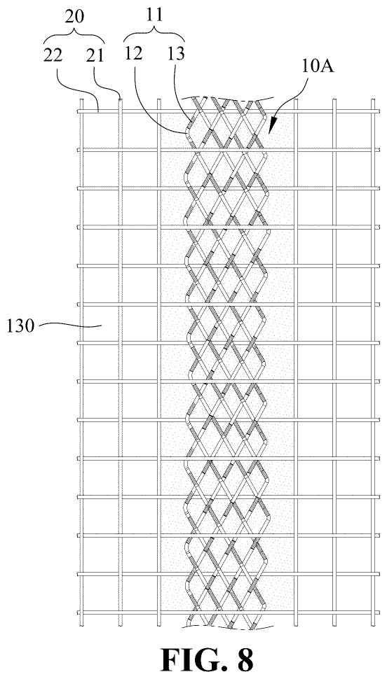

FIG. 7 is a perspective view of a wire damper of loudspeaker 100A of the second embodiment of the present invention. FIG. 8 is a schematic diagram of a region B of FIG. 7. As shown in FIGS. 7 and 8, in terms of structure, the second embodiment is different from the first embodiment in that each multifilament wire 10A is formed by braiding a plurality of the di-filament wires 11.

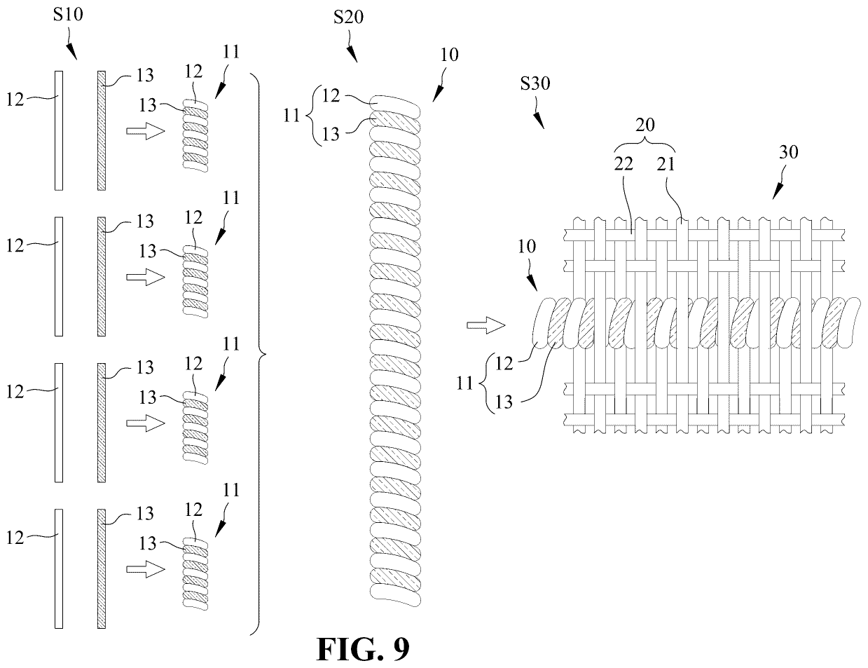

FIG. 9 is a schematic diagram of steps S10 to S30 of a manufacturing method of a third embodiment of the present invention. As shown in FIG. 9, in terms of method, the third embodiment is different from the first embodiment in that in the step S30, the warp yarns 21 extend straightly and are parallel to each other, and the weft yarns 22 and the multifilament wires 10 extend straightly and are perpendicular to the warp yarns 21. Specifically, in the step S30, the warp yarns 21 are arranged at intervals and extend straightly, and the weft yarns 22 and the multifilament wires 10 are arranged at intervals and interwoven with the warp yarns 21 to weave the base material 30.

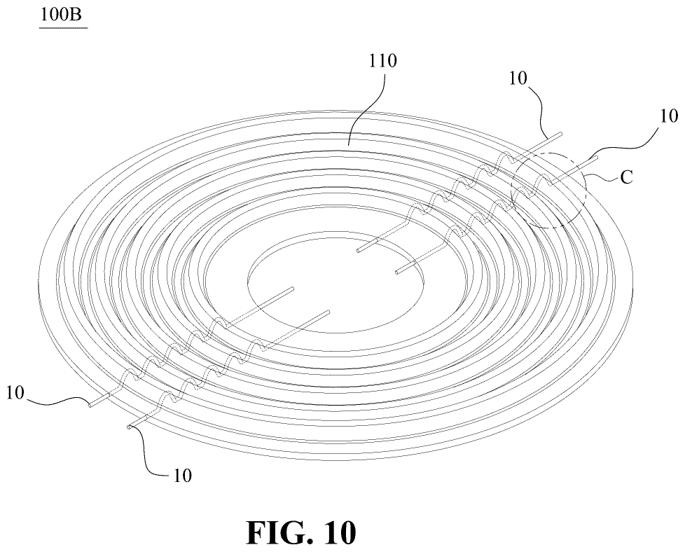

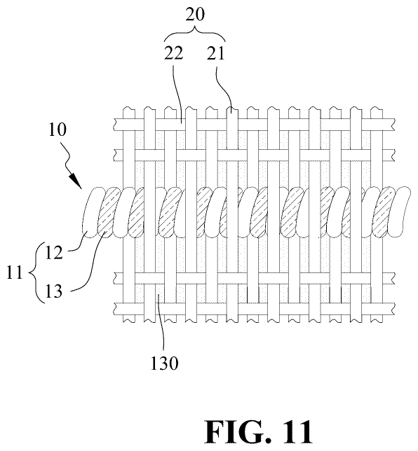

FIG. 10 is a perspective view of a wire damper of loudspeaker 100B of the third embodiment of the present invention. FIG. 11 is a schematic diagram of a region C of FIG. 10; As shown in FIGS. 10 and 11, in terms of structure, the third embodiment is different from the first embodiment in that the warp yarns 21 extend straightly and are parallel to each other, and the weft yarns 22 and the multifilament wires 10 extend straightly and are perpendicular to the warp yarns 21. Specifically, the warp yarns 21 are arranged at intervals and extend straightly, and the weft yarns 22 and the multifilament wires 10 are arranged at intervals and interwoven with the warp yarns 21 to weave the main body 110.

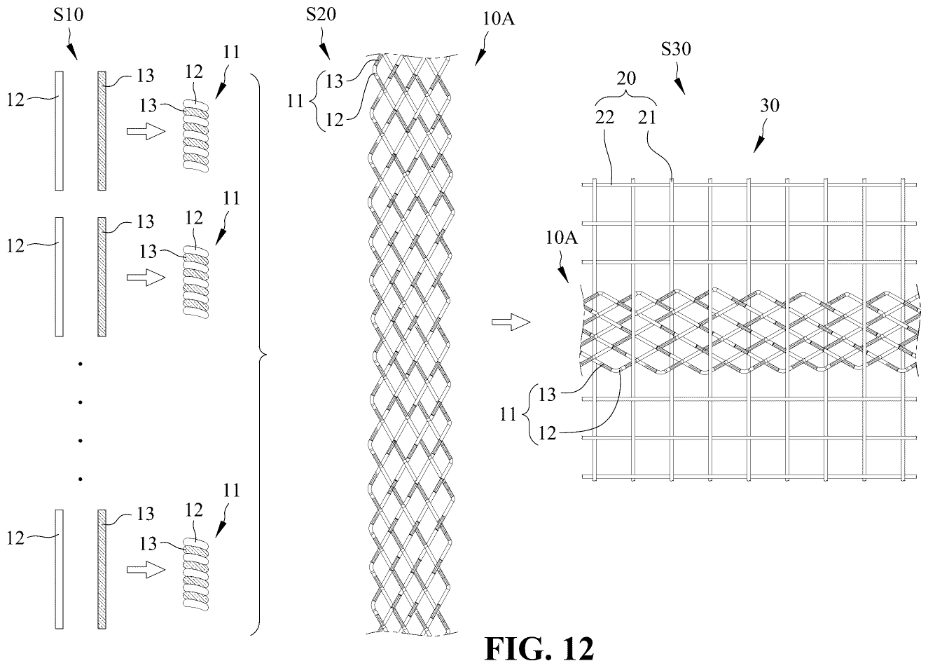

FIG. 12 is a schematic diagram of steps S10 to S30 of a manufacturing method of a fourth embodiment of the present invention. As shown in FIG. 12, in terms of method, the fourth embodiment is different from the second embodiment in that the warp yarns 21 extend straightly and are parallel to each other, and the weft yarns 22 and the multifilament wires 10A extend straightly and are perpendicular to the warp yarns 21. Specifically, in the step S30, the warp yarns 21 are arranged at intervals and extend straightly, and the weft yarns 22 and the multifilament wires 10A are arranged at intervals and interwoven with the warp yarns 21 to weave the base material 30.

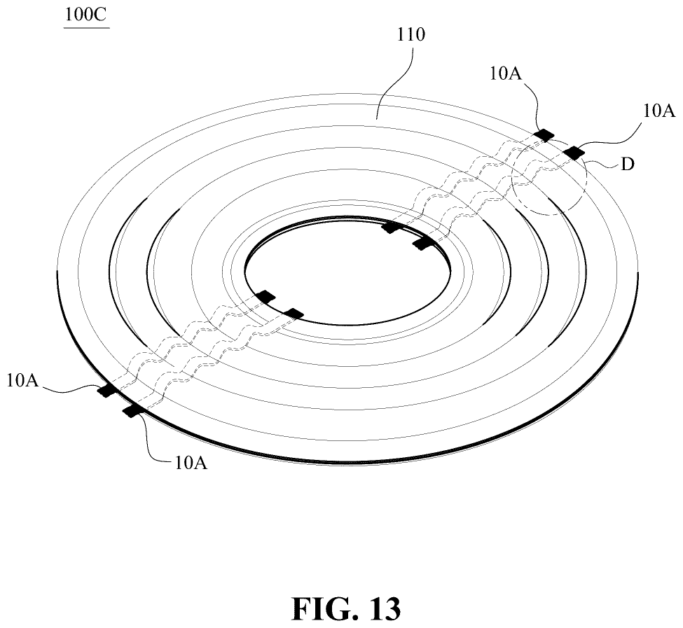

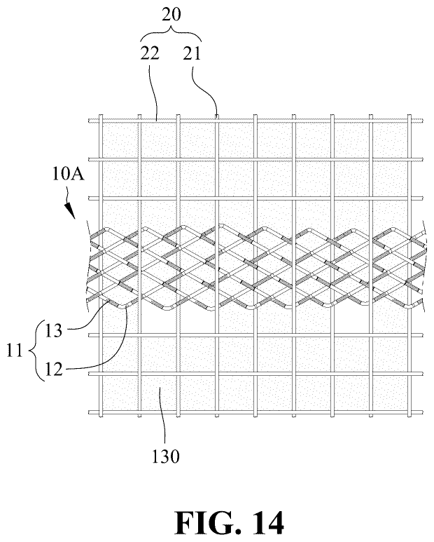

FIG. 13 is a perspective view of a wire damper of loudspeaker 100C of the fourth embodiment of the present invention. FIG. 14 is a schematic diagram of a region D of FIG. 13. As shown in FIGS. 12 and 14, in terms of structure, the fourth embodiment is different from the second embodiment in that the warp yarns 21 extend straightly and are parallel to each other, and the weft yarns 22 and the multifilament wires 10 extend straightly and are perpendicular to the warp yarns 21. Specifically, the warp yarns 21 are arranged at intervals and extend straightly, and the weft yarns 22 and the multifilament wires 10A are arranged at intervals and interwoven with the warp yarns 21 to weave the main body 110.

In summary, the multifilament wires 10 and 10A are formed by blend-twisting or braiding a plurality of di-filament wires 11, which has a better structural strength and is not prone to be damaged due to the heat and pressing of the forming mold 61, and a problem of breakage of the multifilament wires 10 and 10A will not occur even after long-term use.

Furthermore, in the present invention, the materials of the metal yarns 12 and 13 can vary according to different needs. The materials of the metal yarns 12 and 13 may be copper, aluminum, silver, brass, copper alloy, etc., and the present invention is not limited thereto. Copper has good electrical conductivity and is relatively cheap. Aluminum has an electrical conductivity slightly poor than copper, but has a weight lighter than copper. Silver has an electrical conductivity better than copper, but is more expensive. Brass has a better corrosion resistance. Copper alloy have some special properties. In summary, the metal yarns 12 and 13 made of a same material can impart the same electrical properties, and the metal yarns 12 and 13 made of different materials can provide some composite properties depending on the needs.

In addition, the multifilament wires 10 and 10A and the warp yarns 21 can be arranged on a weaving machine simultaneously, such that the multifilament wires 10 and 10A are tighter and have a better structural strength. The multifilament wires 10 and 10A and the weft yarns 22 of the present invention can also be interwoven with the warp yarns 21 through the weaving machine simultaneously, such that the multifilament wires 10 and 10A have a better extensibility, and the conjunction points at both ends of the multifilament wires 10 and 10A will not be easily separated from the voice coil.

Those mentioned above are only preferred embodiments for explaining the present invention, but intend to limit the present invention in any forms. Therefore, any modifications or changes related to the present invention made in the same invention spirit should still be included in the scope of the present invention as intended to be claimed.

What is claimed is:

1. A method for manufacturing a wire damper of a loudspeaker having multifilament wires, comprising the following steps:
blend-twisting two metal yarns into one di-filament wire;
blend-twisting or braiding a plurality of the di-filament wires into one multifilament wire;
weaving a plurality of yarns into a base material, and disposing a plurality of the multifilament wires on the base material;
impregnating the base material in a resin solution;
drying the base material to form a solid resin layer on the base material;
forming a wire damper of a loudspeaker on the base material by thermoforming; and
separating the wire damper of the loudspeaker from the base material.

2. The method according to claim 1, wherein the metal yarns are made of different materials or a same material.

3. The method according to claim 1, wherein in the step of weaving the base material, a plurality of warp yarns of the yarns and the multifilament wires extend straightly and are parallel to each other, and a plurality of weft yarns of the yarns extend straightly and are perpendicular to the warp yarns and the multifilament wires.

4. The method according to claim 1, wherein in the step of weaving the base material, a plurality of warp yarns of the yarns extend straightly and are parallel to each other, and a plurality of weft yarns of the yarns and the multifilament wires extend straightly and are perpendicular to the warp yarns.

5. The method according to claim 1, wherein in the step of weaving the base material, the multifilament wires are woven, sewn, adhered, or sandwiched into the base material.

6. A wire damper of a loudspeaker having multifilament wires, comprising:
a main body, which is woven from a plurality of yarns;
a plurality of multifilament wires, which are disposed on the main body, wherein each multifilament wire is formed by blend-twisting or braiding a plurality of di-filament wires, and each di-filament wire is formed by blend-twisting two metal yarns; and
a solid resin layer, which covers surfaces of the yarns and the multifilament wires.

7. The wire damper of the loudspeaker according to claim 6, wherein the metal yarns are made of different materials or a same material.

8. The wire damper of the loudspeaker according to claim 6, wherein the yarns comprise a plurality of warp yarns and a plurality of weft yarns, the warp yarns and the multifilament wires extend straightly and are parallel to each other, and the weft yarns extend straightly and are perpendicular to the warp yarns and the multifilament wires.

9. The wire damper of the loudspeaker according to claim 6, wherein the yarns comprise a plurality of warp yarns and a plurality of weft yarns, the warp yarns extend straightly and are parallel to each other, and the weft yarns and the multifilament wires extend straightly and are perpendicular to the warp yarns.

10. The wire damper of the loudspeaker according to claim 6, wherein the multifilament wires are woven, sewn, adhered, or sandwiched into the main body.
